(19) United States
(12) Patent Application Publication
(10) Pub. No.: US 2014/0367336 A1
(43) Pub. Date: Dec. 18, 2014

(54) MOLECULAR EXCHANGE DEVICE

(71) Applicant: Probe Scientific Limited, Coventry (GB)

(72) Inventors: Mark Thomas O'Connell, Huntingdon (GB); Stewart Jeffrey Block, London (GB); Rodney Ruston, Milton Keynes (GB)

(73) Assignee: PROBE SCIENTIFIC LIMITED, Coventry (GB)

(21) Appl. No.: 14/308,256

(22) Filed: Jun. 18, 2014

Related U.S. Application Data
(63) Continuation of application No. 12/867,459, filed on Nov. 5, 2010.

(30) Foreign Application Priority Data
Feb. 13, 2008 (GB) 0802669.2

(51) Int. Cl. B01D 63/06; B01D 61/24

(52) U.S. Cl. CPC B01D 63/06; B01D 61/24; B01D 2313/08; B01D 2315/10; B01D 2311/12; B01D 2313/90
USPC 210/644; 210/457; 210/321.87; 210/85

(57) ABSTRACT

The present disclosure relates to a molecular exchange device. In particular, the molecular exchange device comprises at least one fluid passageway and an actuator, the actuator positioned to provide a secondary fluid pathway within at least one of the fluid passageways.

### CROSS-REFERENCE TO RELATED APPLICATIONS

This is a continuation of U.S. patent application Ser. No. 12/867,459, filed Nov. 5, 2010, which is the U.S. National Stage of International Application No. PCT/GB2009/000312, filed Feb. 5, 2009, published in English under PCT Article 21 (2), which claims the benefit of Great Britain Application No. 0802669.2, filed Feb. 13, 2008, all of which are herein incorporated by reference in their entirety.

### DESCRIPTION OF INVENTION

The present invention relates to a molecular exchange device. In particular, the present invention relates to a molecular exchange device for use in monitoring and delivering compounds.

Molecular exchange devices, such as dialysis probes, are known in the art. Such probes relate to use for insertion into a subject, such as in a blood vessel, for use in dialysis, detection of substances or levels of substances within the subject. Such probes generally include a porous membrane past which a perfusion fluid is supplied and removed. Molecules from the perfusion fluid can pass through the membrane into the subject and vice versa. In the latter case, analysis can be carried out using internal or external apparatus to ascertain the presence of certain molecules and their concentrations. Moreover such devices can be used to deliver substances, such as drugs, into a subject.

Known molecular exchange devices have been provided in the form of two or more fluid passageways positioned side by side, with one or both of the fluid passageways have a permeable membrane across which molecular exchange can take place. Devices have also been provided with a single fluid passageway though which fluid may be passed or withdrawn across a permeable membrane.

Molecular exchange devices have also been provided in the form of an outer tube having a lumen with a circular cross-section and an intra-luminal tube also having a circular cross-section positioned centrally within the outer tube, forming what is often referred to as a “concentric arrangement” defining an inner and an outer fluid passageway. The outer tube having a permeable membrane across which molecular exchange can take place. In such an arrangement perfusate fluid may be passed into and along one fluid passageway and drawn along and out of the other fluid passageway.

In order to increase efficiency of such probes, attempts have been made to optimise molecular exchange relative to the perfusate fluid volume and the molecular exchange surface area.

One approach to improve molecular exchange efficiency is to increase the length of the device. However, such a device is more clinically invasive and potentially increases the damage caused by the insertion/removal of the device to/from a subject. Moreover, when the device is being used to sample/analyse perfusate fluid or to deliver drugs/other chemicals for clinical purposes, the increase in the length of the device creates a longer response time. This can delay the analysis of the extracted fluid and have potential clinical implications. Moreover, the increase in length of the device may lead to the relevant tissue for sampling being missed if the functional portion is too long.

An alternative approach is to reduce the perfusate fluid flow rate in order to provide more time for absorption/desporption of analytes across the molecular exchange surface. Again this approach has the undesired effect of increasing the response time that may reduce the clinical usefulness of such a device. In contrast, increasing the perfusate fluid flow rate leads to a decrease in response time, but reduces the adsorption/desporption of analytes across the membrane.

It is an object of the present invention to provide a molecular exchange device that has overcome or mitigates some or all of the above disadvantages.

In a first aspect of the present invention there is provided a molecular exchange device comprising at least one fluid passageway and an actuator; the actuator positioned to provide a secondary fluid pathway within at least one of the fluid passageways. Molecular exchange occurs across a porous region in the external wall of the fluid passageway.

The main advantage provided by the molecular exchange device in accordance with the present invention is that the provision of a secondary fluid pathway for the perfusion fluid passing along the fluid passageway improves the extraction efficiency of the molecular exchange device.

The secondary fluid pathway increases the mixing of the analyte(s) within the perfusate fluid flowing along the fluid passageway. This provides an increase in the uniformity of the distribution of the analyte(s) present in the perfusion fluid and subsequently improves the absorption/desporption of analyte(s) into/from the perfusion fluid that passes along the fluid passageways.

A further advantage provided by the molecular exchange device in accordance with the present invention is that the improved extraction efficiency of the device means that an elongated device having a shorter length can be provided that has the same extraction efficiency of a device having a longer length. The device having a shorter length provides improved feedback times, improved specificity and less damage to the subject during insertion of the device.

In an advantageous embodiment, the molecular exchange device further comprises an outer tube and an inner tube; the inner tube positioned concentrically within the outer tube; the at least one fluid passageway is defined by the area between the inner and the outer tube, wherein the actuator is positioned to provide the secondary fluid pathway within the area between the inner and the outer tube. Molecular exchange occurs across a porous region in the outer membrane.

An additional advantage provided by this embodiment is that the actuator prevents displacement of the inner tube with respect to the outer tube. The maintenance of the inner tube in a concentric position with regard to the outer tube enhances the extraction efficiency of the device, by increasing the absorption/desporption of analytes in perfusate fluid and/or increasing the uniformity of distribution of the analyte of interest throughout the fluid passageway.

In a preferred embodiment, the actuator is in the form of spiral thread. More preferably, the spiral thread extends from and is positioned around the internal circumference of the at least one of the fluid passageway. In an advantageous embodiment, the spiral thread extends from and is positioned around a shaft situated along a central axis of the fluid passageway.

In the embodiment having an inner tube positioned concentrically within an outer tube to define a fluid passageway there between, advantageously the spiral thread extends from and is positioned around the internal wall of the outer tube and/or the external wall of the inner tube.

The spiral thread provides a secondary fluid pathway that has a circular motion, which increases the uniformity of distribution of analyte(s) in the perfusion fluid and subsequently improves the absorption/desporption of analyte(s) into/from the perfusion fluid that passes along the fluid passageway.

In preferred embodiments, the velocity of the perfusate fluid along the fluid passageway is sufficient to ensure that the secondary fluid pathway is maintained after the perfusate fluid has passed through the spiral thread. The turning of the perfusate fluid as it passes along the spiral thread produces pressure differentials that form the secondary pathway even after the fluid has exited the spiral thread. The turning of the perfusion fluid provides cross channel mixing leading to a more uniform concentration of analyte(s) within the perfusion fluid, which increases extraction efficiency.

In an advantageous embodiment the spiral thread is discontinuous along the length of the fluid passageway.

Preferably, the spiral thread is a projection. More preferably, the projection is a single protrusion. Advantageously, the projection is two or more protrusions.

Advantageously, the two or more protrusions define two or more separate fluid passageways in the area between the outer tube and inner tube. The separate fluid passageways may be used for different functions, such as carrying fluids or probes for recording measurements, ascertaining the position of the device and/or analysis. Such probes may be in the form of a fibre or wire.

More advantageously, the projection is in the form of a plurality of protuberants. When perfusate fluid flows over a plurality of protuberants local-mixing occurs at each protuberant, which increases the uniformity of distribution of analyte(s) in the perfusion fluid and subsequently improves the absorption/desporption of analyte(s) into/from the perfusion fluid that passes along the fluid passageways. Advantageously, the protuberants are positioned in a uniform manner around the circumference of the inner tube, in order to improve the uniformity of the distribution of analyte(s) in the perfusate fluid. In a particularly preferred embodiment the plurality of protuberants are positioned in a spiral arrangement around the circumference of the inner tube.

In a preferred embodiment, the actuator extends partially along the length of the fluid passageway. More preferably, the actuator extends along a portion of the fluid passageway that does not permit molecular exchange.

In an advantageous embodiment, the actuator extends along substantially the entire length of the fluid passageway.

In a preferred embodiment the actuator is positioned adjacent to an opening of the fluid passageway.

Preferably, the actuator is rotatable with respect to the fluid passageway. This embodiments improves the mixing the contents of the perfusion fluid thereby increasing the molecular efficiency. In embodiments in which the actuator only extends partially along the fluid passageway, the rotation of the actuator can ensure that the secondary pathway is maintained further along the length of the fluid passageway and, preferably, along a portion across which molecular exchange may occur.

In an advantageous embodiment, the actuator is integral with the fluid passageway. For example, the actuator and the fluid passageway may be formed as a single extrusion.

In a preferred embodiment, the actuator is a propeller. This provides a secondary pathway yet ensures that efficient molecular exchange along the entire fluid passageway. In this arrangement, the propeller drives the fluid in a circular/spiral pathway. The propeller may be driven externally by a magnetic force. The propeller may push or pull fluid to/from the fluid passageway.

In a preferred embodiment, the external wall of the fluid passage way or the outer tube of the concentric embodiment is a porous membrane enabling molecular exchange to occur across any part of the fluid passageway and outer tubing that comes into contact with the external environment of a subject. Advantageously, the external wall or outer tube is a dialysis membrane. In an alternative embodiment the external wall or outer tubing has one or more porous areas where molecular exchange may occur. In embodiments having more than one porous area the porous areas may have different porosities. The porosity of each porous area will depend upon the intended function of the fluid pathway adjacent to the specific porous area.

Preferably, the molecular exchange device further comprises a casing. The casing supports and protects the outer tube.

Advantageously, the proximal end of the device is adapted for attachment to a catheter and/or cannular. More advantageously, the proximal end of the device is a lockable-mating arrangement and or anchoring member for connecting to an invasive port. Conveniently, the proximal end of the device is adapted for attachment to a pump. Preferably, the proximal end of the device is adapted for attachment to an external device.

Advantageously, the device further comprises a sensor arrangement to, preferably, enable spectrologic measurement. More preferably, the spectrologic measurement is spectrophotometric measurement.

Conveniently, the sensor arrangement is a reflector, wave guide, conductor, photoelectric, electro-active or electrochemical sensor.

For the avoidance of doubt, the following terms are intended to have the definitions as outlined below:

Molecular exchange is the selective exchange of any suitable molecule or composition, including but not limited to dialysis, ultra filtration, drug delivery etc. The selective exchange may be transfer of such suitable molecule or composition from the device to the external environment, transfer of such suitable molecule or composition from the external environment to the device or both.

The distal end of the device is the end of the device that can be inserted into the environment in which molecular exchange is desired.

The proximal end of the device is the end of the device that is not intended to be inserted into the environment in which molecular exchange is desired.

The distal and proximal ends of the device are adapted to allow the insertion/withdrawal of perfusion fluid to/from the fluid passageways.

The distal and proximal ends are also adapted to allow insertion/withdrawal of additional components, such as probes, sensors, connectors to monitoring/analysing systems etc.

The extraction efficiency of a molecular exchange device depends on the ability of the device to effectively absorb/desorb compounds of interest in the fluid passageways across the porous area of the outer tube.

The primary fluid pathway of the perfusion fluid is the general direction of flow along the fluid passageway from proximal end to the distal end of the molecular exchange device or vice versa. For example, the general direction of the primary pathway for an elongated molecular exchange device is substantially along the central axis of the fluid passageway running from the proximal to the distal end of the device. The general direction of the primary fluid passageway is shown by arrow ‘A’ in the figures.

The secondary fluid pathway is additional to the general direction of flow of perfusate fluid provided by the primary pathway. The secondary pathway can be in any direction that does not follow the primary pathway. The additional pathway increases the mixing of the analyte(s) within the perfusate fluid. This provides an increase in the uniformity of the distribution of the analyte(s) present in the perfusion fluid and subsequently improves the absorption/desporption of analyte(s) into/from the perfusion fluid that passes along the fluid passageways. In particular, the increase in uniformity of the analyte(s) within the perfusate fluid ensures that the concentration at the surface of the porous area, across which molecular exchange occurs, is higher/lower than it would be in the absence of the secondary pathway, thereby providing a higher concentration gradient across the porous area that increase the rate of absorption/desporption of analyte(s) into/from the perfusion fluid passing along the fluid passageway. This ensures the greatest molecular exchange relative to the surface area and perfusate fluid volume. The general direction of the secondary fluid passageway is shown by arrow ‘B’ in the figures.

The actuator provides the secondary fluid passageway. The actuator can be of any form that provides an alternative pathway for the perfusate fluid additional to the primary pathway.

The outer tube is a hollow cylinder having a substantially circular cross-section. Preferably, the cylinder is elongated.

The inner tube is a hollow cylinder defining at least one fluid passageway. Preferably, the cylinder is elongated. The inner tube is positioned centrally within the outer tube such that the inner and outer tubes share a common central axis, i.e. are in a concentric arrangement.

Preferably, the cross section of at least part of the inner tube is configured to maintain the inner tube in a concentric position within the outer tube, i.e. to prevent lateral displacement of the inner tube from the central position to a eccentric position within the outer tube. The cross-section of the inner tube can be any shape that maintains the position of the inner tube with respect to the outer tube.

The projections may be any shape. The projection may be one or more protrusions or a plurality of protuberants. The protrusions may be any shape and extend radially away from the fluid passageway, shaft, outer tube or inner tube. The protuberants may be any shape.

The porous area permits the exchange of selected molecules to/from the fluid passageway from/to the environment external to the device. The porous areas are porous to the extent that they permit the selective exchange of molecules across the fluid passageway and/or casing. A skilled person would appreciate that different sized molecules will require different porosities to permit the selective exchange of molecules.

The porous area may be substantially along the entire length of the fluid passageway. Alternatively the porous area may be a portion of the fluid passageway that is exposed to the external environment. The porous area may be exchanged to the external environment by an opening in a casing covering the fluid passageway.

The subject is any suitable environment in which the device may be applied. For example, the subject can be a human or animal body. Alternatively, the subject could be a vessel that is part of an industrial, chemical or fermentation process.

In order that the present invention may be more readily understood, non limiting embodiments thereof will now be described, by way of example, with reference to the accompanying drawings in which:

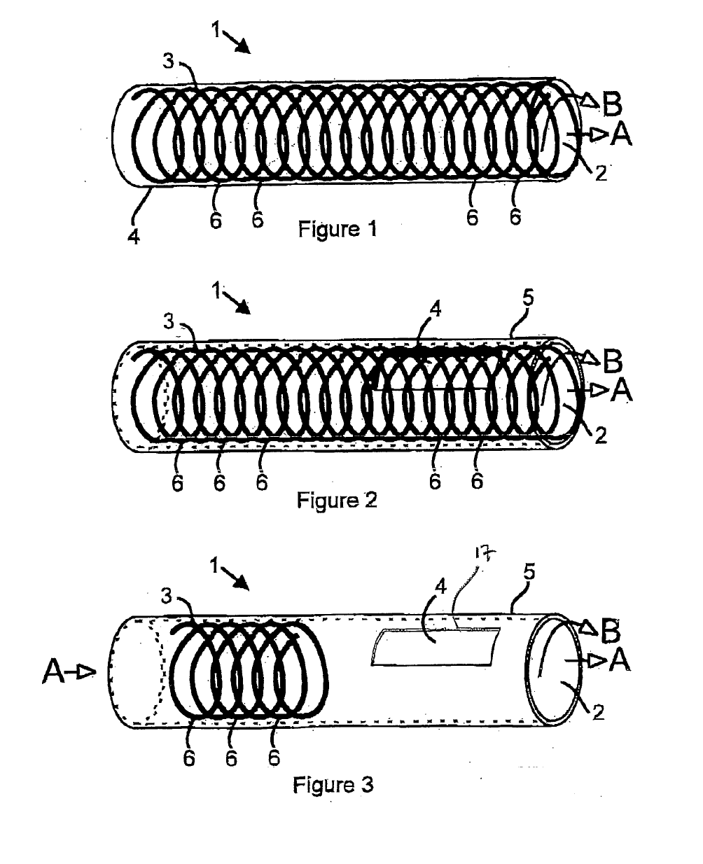

FIG. 1 is a first embodiment of a molecular exchange device in accordance with the present invention;

FIG. 2 is an alternative embodiment of a molecular exchange device in accordance with the present invention;

FIG. 3 is an alternative embodiment of a molecular exchange device in accordance with the present invention;

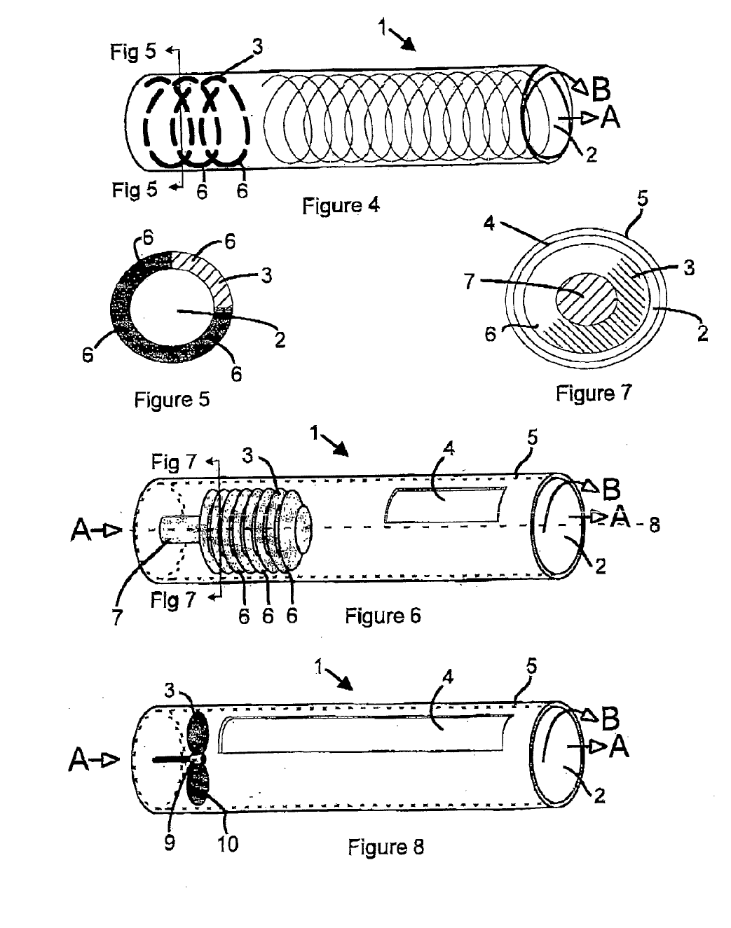

FIG. 4 is an alternative embodiment of a molecular exchange device in accordance with the present invention;

FIG. 5 is a cross-section view of the alternative embodiment illustrated in FIG. 4;

FIG. 6 is an alternative embodiment of a molecular exchange device in accordance with the present invention;

FIG. 7 is a cross-section view of the alternative embodiment illustrated in FIG. 6;

FIG. 8 is an alternative embodiment of a molecular exchange device in accordance with the present invention;

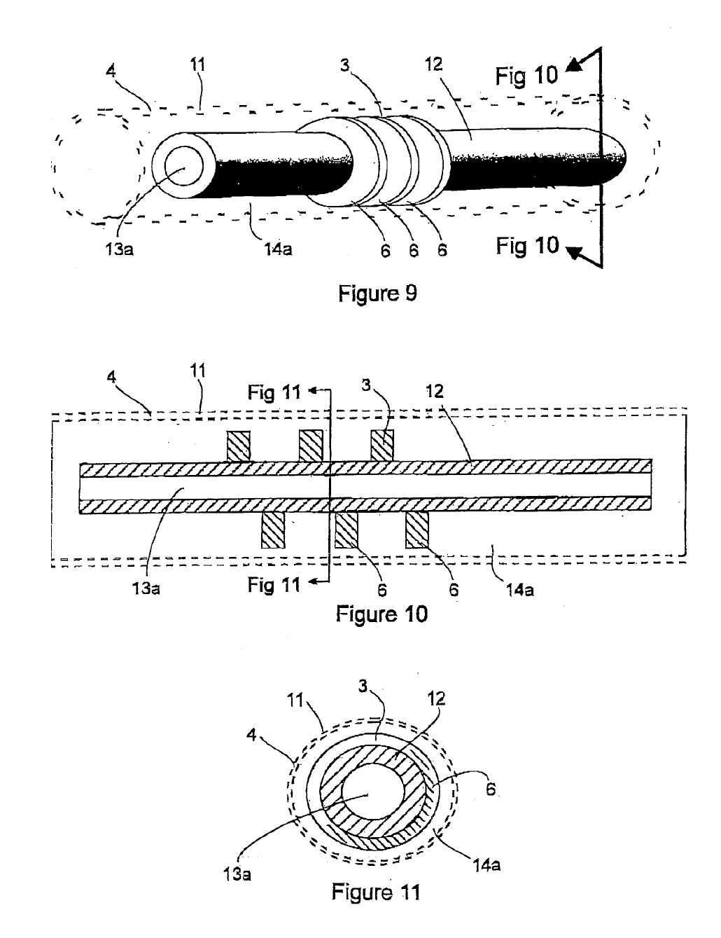

FIG. 9 is an alternative embodiment of a molecular exchange device in accordance with the present invention;

FIG. 10 is a plan view of the inner tube and actuator illustrated in FIG. 9;

FIG. 11 is a mid-line cross-section of the inner tube and actuator illustrated in FIG. 10;

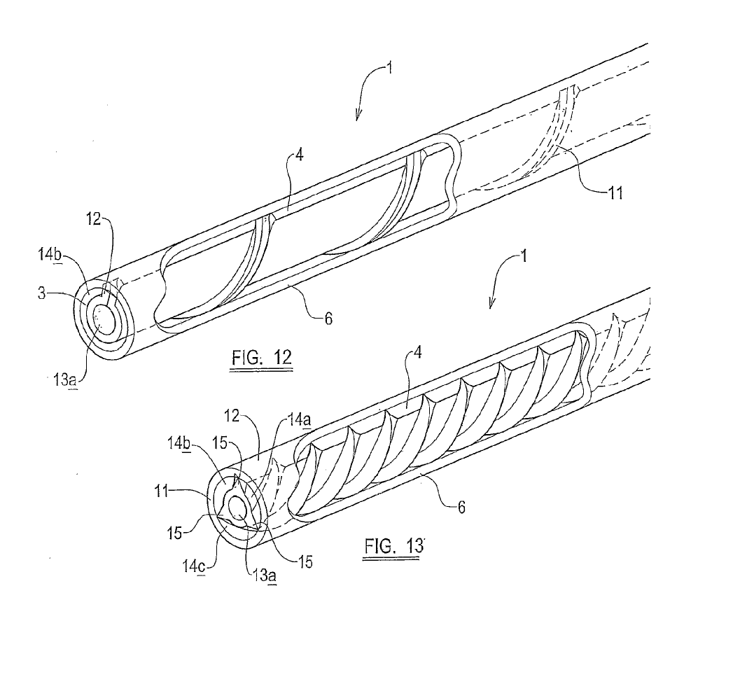

FIG. 12 is an alternative embodiment of a molecular exchange device in accordance with the present invention;

FIG. 13 is an alternative embodiment of a molecular exchange device in accordance with the present invention;

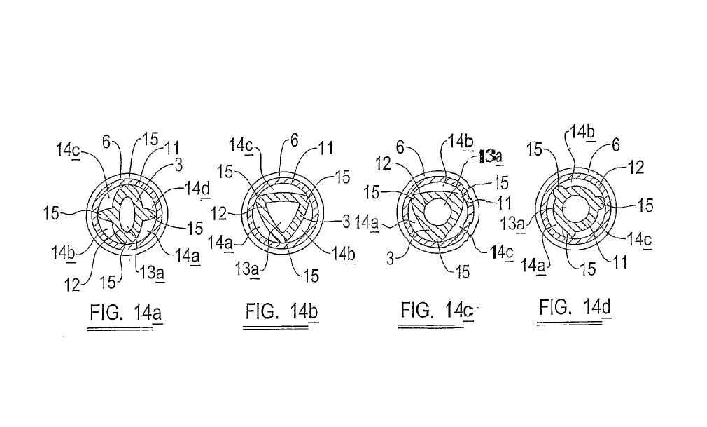

FIGS. 14a to 14d are cross-sectional views of alternative embodiments of a molecular exchange device in accordance with the present invention illustrated in FIG. 10;

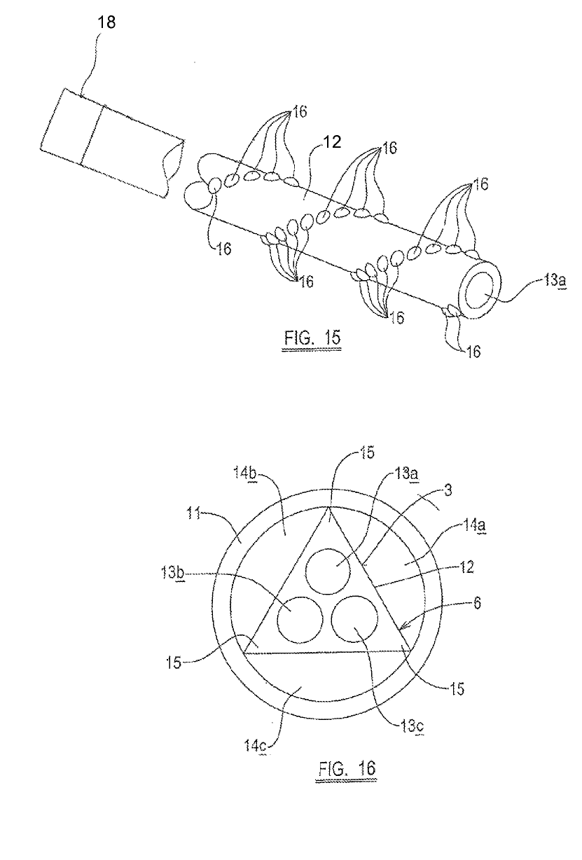

FIG. 15 is an alternative embodiment of an inner tube and projection of a molecular exchange device in accordance with present invention;

FIG. 16 is a cross-section view of an alternative embodiment of a molecular exchange device in accordance with the present invention.

As illustrated in FIG. 1, there is a first embodiment of a molecular exchange device (1) according to the present invention comprising a fluid passageway (2) and an actuator (3). The fluid passageway (2) is suitable for fluid travel within the passageway. The fluid may be supplied to or drawn from the fluid passageway (2).

In this embodiment, the fluid passageway (2) is in the form of a porous membrane (4) that allows selective molecular exchange of molecules in one or both directions across the membrane (4). The level of porosity of the porous membrane will depend upon the intended use of the molecular device (1). The porosity enables a specific molecule or composition to cross the membrane (4) from the environment external to the passageway (2) and vice versa, for a particular use of the molecular exchange device (1).

In this embodiment, the actuator (3) is in the form of a spiral thread (5) positioned around the internal circumference of the fluid passageway (2), and extending substantially along the entire length of the passageway (2). The spiral thread (6) is a single projection arranged such that perfusion fluid and molecules can pass across the membrane (4) of the fluid passageway (2). In this embodiment, the fluid passageway (2) is not covered by a casing and, as such, molecular exchange may occur along the entire passageway (2).

In an alternative embodiment illustrated in FIG. 2, a casing (5) is provided around the fluid passageway (2) in the areas in which molecular exchange is not desired. The casing (5) may be in any form that prevents molecular exchange, such as a sheath or coating. Molecular exchange is only possible across a portion of the membrane (4) that is not covered by a casing (5). For example, the portion of the membrane (4) that is not covered by the casing (5) may be in the form of an aperture (17). The aperture (17) may be formed, for example, by removing a portion of the casing (5).

In use, perfusion fluid is supplied into the fluid passageway (2) and passed along the fluid passageway (2) such that it follows the secondary pathway provided by the actuator (3) in the form of a spiral thread (6). The actuation of the secondary pathway has the effect of mixing the perfusion fluid and analyte(s), which are absorbed into or desorbed from the fluid passageway (2) across the membrane (4), to provide a more uniform concentration of the analyte(s) in the perfusion fluid, across the cross section of the fluid passageway (2), than in the absence of the actuator (3). The provision of a more uniform concentration of molecules within the perfusion fluid inside the fluid passageway (2) ensures a higher concentration gradient across the porous membrane (4), thereby increasing the efficiency of molecular exchange across the membrane (4).

In the embodiment shown in FIG. 3, the actuator (3) is in the form of a spiral thread (6). The spiral thread (6) is a single projection and positioned around the internal circumference of the fluid passageway (2), extending from and partially along the length of the passageway (2). The actuator (3) is not integral with the fluid passageway (2). The actuator (3) is positioned adjacent to a portion of the passageway across which molecular exchange can occur, i.e. the actuator (3) sits in a portion of the fluid passageway (2) where molecular exchange does not take place.

In use, perfusion fluid is supplied into the fluid passageway (2) and passed along the fluid passageway (2) such that it follows the secondary pathway provided by the actuator (3) in the form of a spiral thread (6). The perfusion fluid is supplied to/from the fluid passageway (2) at a velocity that provides sufficient momentum for the perfusion fluid to follow the secondary pathway provided by the spiral thread (3) and maintain the secondary pathway as it exits the thread (6) and passes along the portion of the fluid passageway (2) across which molecular exchange may occur.

The actuation of the secondary pathway has the effect of mixing the perfusion fluid and the analyte(s), which are absorbed into or desorbed from the fluid passageway (2) across the membrane (4), to provide a more uniform concentration of the analyte(s) in the perfusion fluid, across the cross section of the fluid passageway (2), than in the absence of the actuator. The provision of a more uniform concentration of molecules within the perfusion fluid inside the fluid passageway (2) ensures a higher concentration gradient across the porous membrane (4), thereby increasing the efficiency of molecular exchange across the membrane (4).

The positioning of the actuator (3), as illustrated in FIG. 3, allows maximum molecular exchange to occur across the membrane (4) of the fluid passageway (2) that is not covered by the casing (5). The secondary pathway provided by the actuator (3) is maintained along the portion of the fluid passageway (2) across which molecular exchange may take place, without reducing the surface area across which molecular exchange can occur.

In an alternative embodiment, as shown in FIG. 4, the actuator (3) is in the form of a discontinuous spiral thread (6) positioned around the internal circumference of the fluid passageway (2), which provides a secondary pathway. The spiral thread (3) is a single projection that extends partially along the length of the fluid passageway (2). However, the discontinuous spiral thread (6) may be positioned along substantially the entire length of the fluid passageway (not shown). In both arrangements the secondary fluid pathway is maintained along the fluid passageway (2) adjacent to a portion of the membrane (4) across which molecular exchange may take place. In the embodiment of FIG. 4, the portion of the membrane (4) across which molecular exchange can take place (not shown) is the area of the membrane (4) that is not covered by the casing (5).

FIG. 5 shows a cross sectional view of this embodiment, showing the discontinuous arrangement of the spiral thread (6).

In a further embodiment illustrated in FIG. 6, the actuator (3) is in the form of a rotatable shaft (7) having a spiral thread (6) positioned around the external circumference thereof. The shaft (7) is positioned along and rotates about the central axis (8) of the fluid passageway (2), such that it is rotatable with respect to the fluid passageway (2). The cross-sectional view of this embodiment is shown in FIG. 7. In this embodiment the actuator (3) extends only partially along the fluid passageway (2). It is envisaged that the actuator could extend along substantially the entire length of the fluid passageway (not shown).

During the use of the device illustrated by FIG. 6, the perfusion fluid passes along the portion of the fluid passageway (2) in which the actuator (3) is positioned. The spiral thread (6) and the rotation thereof, due to the rotation of the shaft (7), provide a secondary pathway for the perfusion fluid. As will be appreciated by a skilled person, the rotatable shaft (7) and spiral thread (6) must be of a sufficient size, and have a sufficient rotational speed, to ensure that the secondary fluid pathway can be maintained once the fluid has exited the portion of the fluid passageway (2) in which the actuator (3) is positioned. This ensures that the secondary pathway for the perfusion fluid is present along the length of the fluid passageway (2) across which molecular exchange may occur.

The present invention also incorporates embodiments in which the actuator is positioned outside of the fluid passageway, adjacent to an opening of the fluid passageway. In embodiments in which the actuator is in the form of a spiral thread, the secondary pathway is maintained along the fluid passageway in the same manner in which is maintained along the fluid passageways in the above embodiments in which actuator does only extends partially along the length of the fluid passageway.

In an alternative embodiment shown in FIG. 8, the actuator (3) is in the form of a propeller (9). In this embodiment the propeller (9) is positioned within the fluid passageway. However, it is envisaged that the propeller (9) may be positioned outside of the fluid passageway (2), adjacent to an opening thereof. In this embodiment the propeller blades (10) rotate within the fluid passageway. The rotation of the blades (10) creates a secondary fluid pathway for the perfusion fluid flowing along the fluid passageway (2). The fluid flows at a velocity and the blades (10) rotate at a speed that are sufficient to ensure that the secondary fluid pathway is maintained along the fluid passageway. In this embodiment the fluid passageway is covered by a casing (5) in areas in which molecular exchange is not desired. Molecular exchange may occur across the porous membrane (4) that is not covered by the casing (5). In this embodiment the fluid may be supplied to or drawn from the fluid passageway (2).

In the embodiment shown in FIG. 8, the propeller (9) is positioned before the exposed porous membrane (4) such that, when the fluid is supplied to the fluid passageway (2), the fluid is pushed over the propeller (9). Alternatively, the propeller (9) may be positioned after the exposed porous membrane (4) and, as such, the fluid is pulled over the propeller (9). In a further embodiment, one or more propellers (9) may be positioned before and/or after the exposed porous membrane (4).

It is to be appreciated that the above embodiments of a molecular exchange device may be applied to any fluid passageway of a molecular exchange device, in particular those have singular or multiple fluid passageways positioned adjacent to one another. The embodiments may also be applied to flat molecular exchange devices.

In an alternative embodiment of the invention, as illustrated in FIG. 9, an outer tube (11) and an inner tube (12), the inner tube (12) defining a fluid passageway (13a). The inner tube (12) is positioned concentrically within the outer tube (11). The area between the outer tube (11) and the inner tube (12) defining a fluid passageway (14a). The fluid passageways (13a, 14a) are suitable for fluid to travel within the passageway. The fluid may be supplied to or drawn from the fluid passageways (13a, 14a). The outer tube (11) may be open at both ends such that the fluid can pass from the proximal end to the distal end of the device for collection at the distal end. This embodiment could be advantageously used in linear microdialysis. Alternatively, the outer tube may be sealed at the distal end, for use in concentric microdialysis (not shown), so that the fluid flows from the proximal end to the distal end and returns to the proximal end for collection.

In this embodiment, the outer tube (11) is in the form of a porous membrane (4) that allows selective molecular exchange of analytes in one or both directions across the membrane (4). The level of porosity of the porous membrane (4) will depend upon the intended use of the molecular device (1). The porosity enables a specific molecule or composition to cross the membrane from the environment external to the outer tube (11) and vice versa, for a particular use of the molecular exchange device (1).

A casing (not shown) may be provided around the outer tube (11) in the areas in which molecular exchange is not desired. The casing may be in any form that prevents molecular exchange, such as a sheath or coating.

As shown in more detail in FIGS. 10 and 11, in this embodiment the actuator (3) is in the form of a spiral thread positioned around the external circumference of the inner tube (12). The spiral thread (6) is in the form of a single projection that extends partially along the device (1), within the area between the outer tube (11) and the inner tube (12). In this embodiment the actuator (3) provides a secondary fluid pathway and prevents the lateral displacement of the inner tube (12) with respect to the outer tube (11). This arrangement increases or maintains the extraction efficiency of the device (1).

As shown in FIG. 12, the actuator (3) may extend along the entire length of the fluid passageway (2).

In an alternative embodiment illustrated in FIG. 13, the actuator (3) is in the form of a spiral thread (6) positioned around the external circumference of the inner tube (12). The spiral thread (6) is three projections (15) that each extend from and along the length of the inner tube (12). In this embodiment the projections (15) are integral with the inner tube (12) and extend continuously along substantially the entire length of the inner tube (12).

As shown in FIG. 13, the projections (15) define three fluid passageways (14a, b, c). This arrangement for the fluid passageways (14a, 14b, 14c) provides a secondary fluid pathway within each of the fluid passageways (14a, 14b, 14c), which increases the uniformity of distribution of analyte(s) in the perfusion fluid and subsequently improves the absorption/desporption of analyte(s) into/from the perfusion fluid that passes along the fluid passageways (14a, 14b, 14c).

Also as shown in FIGS. 14a, 14b, 14c and 14d, the projections define multiple separate fluid passageways (14a, 14b, 14c, 14d) in the area between the outer and inner tubes (11, 12). The fluid passageway (14a) may have the same properties (for example porosity) as the other fluid passageways (14b, 14c, 14d) and used for the same function. Alternatively, the separate fluid passageways (14a, 14b, 14c, 14d) could be used to supply and/or absorb different molecules/compositions and, as such, have different properties to one another.

In an alternative embodiment, the actuator (3) is in the form of a plurality of protuberants (16) positioned in a spiral arrangement around the circumference of the inner tube (12), as illustrated in FIG. 15. During use, the perfusate fluid passes along the fluid passageways (14a) and flows over the plurality of protuberants (16) causing local-mixing occurs at each protuberant (16), thereby providing a secondary fluid pathway.

As illustrated in FIG. 16, in a further embodiment the molecular exchange device comprises an inner tube (12) defining three fluid passageways (13a, 13b, 13c). The actuator (3) is in the form of three protrusions (15), extending around the external circumference of the inner tube (12) and continuously along substantially the entire length thereof, that define three separate fluid passageways (14a, 14b, 14c) in the area between the outer tube (11) and inner tube (12). Each one of the fluid passageways (13a, 13b, 13c) is in fluid communication with a respective fluid passageway (14a, 14b, 14c).

In use, it is envisaged that each set of respective fluid passageways (13a: 14a, 13b: 14b, 13c: 14c) will be suitable for different functions. For example, fluid may be passed along a first fluid passageway (13a), from the proximal end to the distal end of the device (1). The fluid is then passed from the distal end to the proximal end of the device along a respective first fluid passageway (14a). As the fluid passes along the respective fluid passageway (14a), the fluid is exposed to the external environments at porous areas (4) of the outer tube (11), permitting the selective exchange of analyte(s) across the porous membrane (4). Such a first set of fluid passageways (13a, 14a) is used to analyse the concentration of a specific analyte in the external environment in which the device (1) has been placed. Fluid may be passed in a similar manner along a second set of respective fluid passageways (13b, 14b). The second set of fluid passageways (13b, 14b) delivers a drug into the external environment in an amount dependent on the analysis of the first fluid passageway. The third set of fluid passageways (13c, 14c) carries further perfusion fluid. The further perfusion fluid may be a different composition to that in the first and second set of fluid passageways (13a, 14a; 13b, 14b) and/or have a different flow velocity to that in the first and second set of fluid passageways (13a, 14a; 13b, 14b). Furthermore, a probe for monitoring and analysis may be present in one or more of the fluid passageways.

It is to be appreciated that the form of projection for a specific device will depend upon the intended function of the device. The physical parameters of the analyte and perfusate fluid (for example, density, viscosity, concentration, diffusivity), flow rates, response time and size of the inner and outer tubes will determine which form of projection is most efficient for a specific use.

The molecular exchange device of the present invention and one or more external devices can be used to analyse, measure or deliver industrial, chemical, fermentation and animal or plant compositions. The molecular exchange device may be used in a vessel of industrial, chemical or fermentation processes and the human or animal body.

The molecular exchange device according to the present invention is intended to be used in the human or animal bodies in any tissue or organ including but not restricted to the circulatory system, insertion into blood vessels, lymphatic system, muscles, ear, mouth, tissue fat and internal organs.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A molecular exchange device comprising:
at least one fluid passageway; and
an actuator, the actuator positioned to provide a secondary fluid pathway within at least one of the fluid passageways;
further comprising an outer tube and an inner tube, the inner tube positioned concentrically within the outer tube, the at least one fluid passageway being defined by the area between the inner and the outer tube such that the at least one fluid passageway extends along the entire length of the molecular exchange device, wherein the actuator is positioned to provide the secondary fluid pathway within the area between the inner and the outer tube, wherein at least a portion of the outer tube is a porous membrane;
wherein the actuator is in the form of a spiral thread, the spiral thread comprising two or more projections, such that the projections define multiple separate fluid pathways in the area between the outer and inner tubes;
wherein molecules in an external fluid can migrate across the porous membrane into the at least one fluid passageway so as to mix with a perfusate fluid, wherein the mixture flows through the at least one fluid passageway.

2. A molecular exchange device according to claim 1, wherein the spiral thread extends from and is positioned around the internal circumference of the at least one of the fluid passageway.

3. A molecular exchange device according to claim 1, wherein the spiral thread extends from and is positioned around the inner tube.

4. A molecular exchange device according to claim 1, wherein the spiral thread extends from and is positioned around the internal wall of the outer tube and/or the external wall of the inner tube.

5. A molecular exchange device according to claim 1, wherein the actuator extends partially along the length of the at least one fluid passageway.

6. A molecular exchange device according to claim 5, wherein the actuator extends along a portion of the at least one fluid passageway that does not permit molecular exchange.

7. A molecular exchange device according to claim 1, wherein the actuator extends along substantially the entire length of the at least one fluid passageway.

8. A molecular exchange device according to claim 1, wherein the actuator is positioned adjacent to an opening of the at least one fluid passageway.

9. A molecular exchange device according to claim 1, wherein the actuator is integral with the fluid passageway.

10. A molecular exchange device according to claim 1, further comprising a casing.

11. A molecular exchange device according to claim 1, wherein:
the proximal end of the device is adapted for attachment to a catheter and/or cannular.

12. A molecular exchange device according to claim 1, further comprising a sensor arrangement to enable spectrologic measurement.

13. A molecular exchange device according to claim 12, wherein the spectrologic measurement is spectrophotometric measurement.

14. A molecular exchange device according to claim 13, wherein the sensor arrangement is a reflector, wave guide, conductor, photoelectric, electro-active or electrochemical sensor.

15. A molecular exchange device according to claim 1, wherein the proximal end of the device is a lockable-mating arrangement and/or anchoring member for connecting to an invasive port.

16. A molecular exchange device according to claim 1, wherein the proximal end of the device is adapted for attachment to a pump.

17. A molecular exchange device according to claim 1, wherein the proximal end of the device is adapted for attachment to an external device.

18. A method of using the molecular exchange device of claim 1, comprising:
passing a perfusate fluid through the at least one fluid passageway;
actuating the perfusate fluid within the at least one fluid passageway such that molecules located in an external fluid cross through the porous membrane and mix with the perfusate fluid in the at least one fluid pathway; and
withdrawing the mixture from the molecular exchange device.
